(19) United States
(12) Patent Application Publication
(10) Pub. No.: US 2016/0075376 A1
(43) Pub. Date: Mar. 17, 2016

(54) PARKING ASSIST SYSTEM, PARKING ASSIST METHOD AND PARKING ASSIST CONTROL PROGRAM

(71) Applicants: AISIN SEIKI KABUSHIKI KAISHA, Kariya-shi (JP); TOYOTA JIDOSHA KABUSHIKI KAISHA, Toyota-shi (JP)

(72) Inventors: Motokatsu TOMOZAWA, Nagoya-shi (JP); Masaya KATO, Toyokawa-shi (JP); Shogi FUKUKAWA, Nagoya-shi (JP); Yuichi MIZUTANI, Chita-gun (JP); Takatomo ASAI, Nagoya-shi (JP); Motonari OBAYASHI, Nagakute-shi (JP); Hironobu ISHIJIMA, Toyota-shi (JP)

(73) Assignees: TOYOTA JIDOSHA KABUSHIKI KAISHA, Toyota-shi (JP); AISIN SEIKI KABUSHIKI KAISHA, Kariya-shi (JP)

(21) Appl. No.: 14/850,041

(22) Filed: Sep. 10, 2015

(30) Foreign Application Priority Data
Sep. 12, 2014 (JP) 2014-186782

(51) Int. Cl. B62D 15/02; B60N 2/44

(52) U.S. Cl. CPC B62D 15/0285; B62D 15/0275; B62D 15/025; B62D 15/029; B60N 2/44; B60N 2002/4485

(57) ABSTRACT

A parking assist system includes an electronic control unit. The electronic control unit is configured to detect that a vehicle has moved through a switching position and reached a predetermined state during parking assist for the vehicle, and, when it is detected that the vehicle has reached the predetermined state, provide a notice that the vehicle has reached the predetermined state by imparting a predetermined vibration to a steering wheel of the vehicle.

### INCORPORATION BY REFERENCE

The disclosure of Japanese Patent Application No. 2014-186782 filed on Sep. 12, 2014 including the specification, drawings and abstract is incorporated herein by reference in its entirety.

### BACKGROUND OF THE INVENTION

1. Field of the Invention

The invention relates to a parking assist system, a parking assist method and a parking assist control program.

2. Description of Related Art

As a technique for assisting in parking a vehicle, there is suggested a technique for providing a driver with image data captured as a surrounding environment of the vehicle by a plurality of cameras installed in the vehicle. At this time, there is suggested a technique for assisting in, for example, parking a vehicle by displaying a predicted moving trajectory in the case where the vehicle moves in the future at a steering angle of the vehicle.

In this case, in order to park a vehicle in a place, such as a parking place, in which a movable range of a vehicle is limited, it is generally required to maneuver a steering wheel. Therefore, when a vehicle has reached a switching position at which the steering wheel is turned, a driver is informed through video image that the vehicle has reached the switching position (for example, Japanese Patent Application Publication No. 2012-073836 (JP 2012-073836 A)).

### SUMMARY OF THE INVENTION

However, for example, when the driver does not recognize the displayed video image showing that the vehicle has reached the switching position or when a display is a meter display and the display is hidden by the steering wheel, information on the display is not visually recognized, with the result that the vehicle passes through the switching position. When parking assist is performed, it is desired to reliably provide the driver with a notice that the vehicle has reached the switching position and passed through the switching position.

A first aspect of the invention provides a parking assist system. The parking assist system includes an electronic control unit. The electronic control unit is configured to detect that a vehicle has moved through a switching position at which the steering wheel is required to turn and reached a predetermined state during parking assist for the vehicle, and, when it is detected that the vehicle has reached the predetermined state, provide a notice that the vehicle has reached the predetermined state by imparting a predetermined vibration to a steering wheel of the vehicle.

A second aspect of the invention provides a parking assist method that is executed in a parking assist system mounted on a vehicle including a driving unit that rotationally drives a steering wheel. The parking assist method includes: detecting that the vehicle has moved through a switching position at which the steering wheel is required to turn and reached a predetermined state during parking assist for the vehicle; and, when it is detected that the vehicle has reached the predetermined state, providing a notice that the vehicle has reached the predetermined state by imparting a vibration by switching between rotation of the steering wheel in a first direction and rotation of the steering wheel in a second direction opposite to the first direction.

A third aspect of the invention provides a control program for controlling, by a computer, a parking assist system mounted on a vehicle including a driving unit that rotationally drives a steering wheel. The control program causes the computer to function as: means for detecting that the vehicle has moved through a switching position at which the steering wheel is required to turn and reached a predetermined state during parking assist for the vehicle; and means for, when it is detected that the vehicle has reached the predetermined state, providing a notice that the vehicle has reached the predetermined state by controlling the driving unit to impart a vibration by switching between rotation of the steering wheel in a first direction and rotation of the steering wheel in a second direction opposite to the first direction.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an exemplary perspective view of a vehicle according to an embodiment in a state where part of a cabin is seen through;

FIG. 2 is an exemplary plan view (bird's-eye view) of the vehicle according to the embodiment;

FIG. 3 is a view of an example of a dashboard of the vehicle according to the embodiment when viewed from the rear side of the vehicle;

FIG. 4 is an exemplary block diagram of the configuration of a parking assist system according to the embodiment;

FIG. 5 is an exemplary block diagram of the configuration of an ECU of the parking assist system according to the embodiment;

FIG. 6 is a flowchart that shows a schematic process according to the embodiment;

FIG. 7 is a view that illustrates detection of an available parking area;

FIG. 8 is a view that illustrates a reflected portion of an obstacle;

FIG. 9 is a view that illustrates an available parking area;

FIG. 10 is a view that illustrates an example of setting of a moving path;

FIG. 11 is a process flowchart of a parking assist control process;

FIG. 12 is a view that illustrates an example of display at the start of the parking assist control process;

FIG. 13 is a view that illustrates an example of display in the case where a host vehicle position has reached a switching position;

FIG. 14 is a view that illustrates a state of a steering unit during the parking assist control process;

FIG. 15 is a side view for illustrating a method of calculating a visually recognizable position of a display screen of a display device;

FIG. 16 is a plan view for illustrating the method of calculating a visually recognizable position of the display screen of the display device;

FIG. 17 is a view that illustrates a state after the steering unit is driven to a position at which the display device is visually recognizable;

### DETAILED DESCRIPTION OF EMBODIMENTS

Hereinafter, an exemplary embodiment of the invention will be described. The configuration of the embodiment described below, and the operation, results and advantageous effects obtained from the configuration are illustrative. The invention may be implemented by a configuration other than the configuration that will be described in the following embodiment, and may obtain at least one of various advantageous effects based on a basic configuration or secondary advantageous effects.

A vehicle 1 according to the present embodiment may be, for example, an automobile that uses an internal combustion engine (not shown) as a drive source, that is, an internal combustion engine automobile, may be an automobile that uses an electric motor (not shown) as a drive source, that is, an electric automobile, a fuel-cell automobile, or the like, may be a hybrid automobile that uses both the internal combustion engine and the electric motor as drive sources, or may be an automobile including another drive source. Various transmissions may be mounted on the vehicle 1. Various devices, such as system and components, required to drive an internal combustion engine or an electric motor may be mounted on the vehicle 1. The system, number, layout, and the like, of a device related to driving of wheels 3 in the vehicle 1 may be variously set.

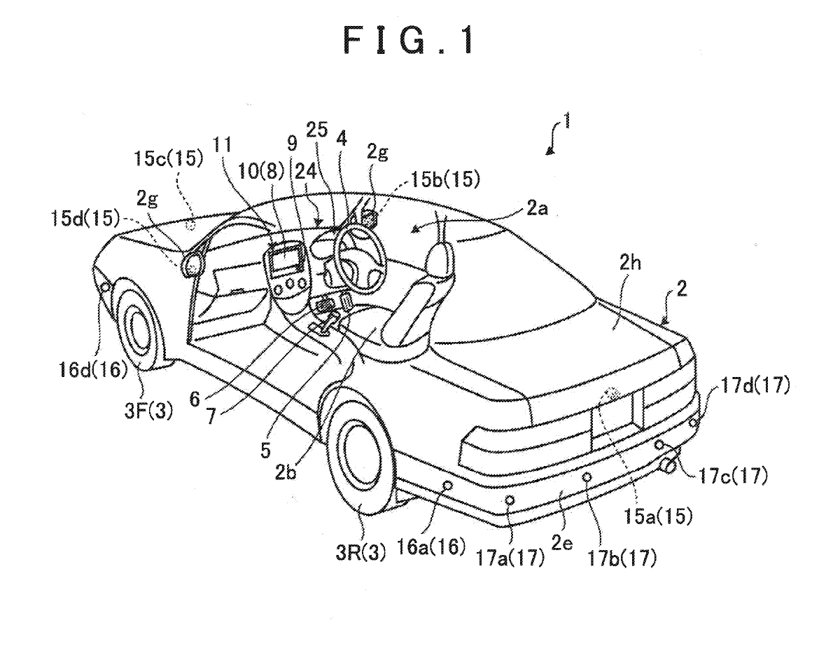

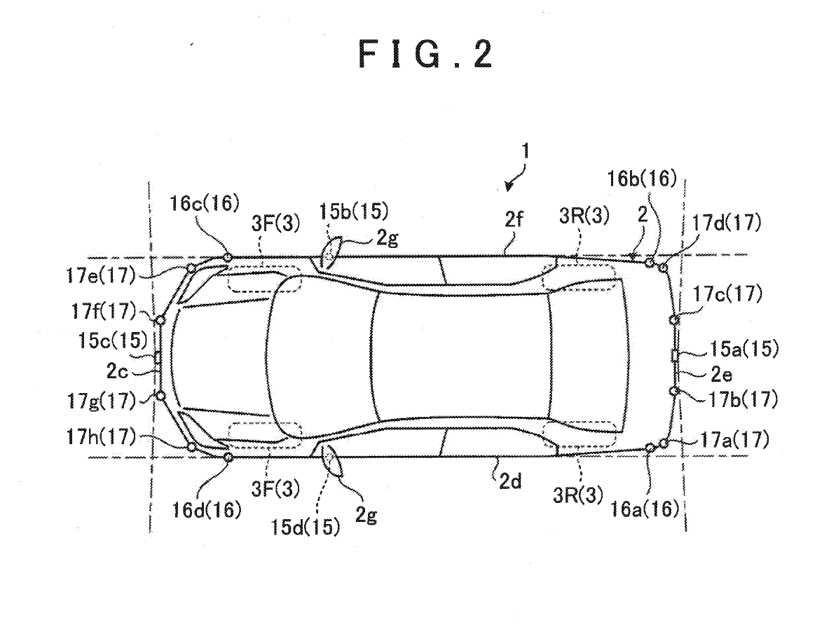

FIG. 1 is an exemplary perspective view of a vehicle according to the embodiment in a state where part of a cabin is seen through. FIG. 2 is an exemplary plan view (bird's-eye view) of the vehicle according to the embodiment. As illustrated in FIG. 1, a vehicle body 2 constitutes a cabin 2a in which an occupant (not shown) is seated. A steering unit 4, an accelerator operation unit 5, a brake operation unit 6, a shift operation unit 7, and the like, are provided near a seat 2b of a driver as an occupant inside the cabin 2a. The steering unit 4 is, for example, a steering wheel projecting from a dashboard 24. The accelerator operation unit 5 is, for example, an accelerator pedal located near driver's foot. The brake operation unit 6 is, for example, a brake pedal located near driver's foot. The shift operation unit 7 is, for example, a shift lever projecting from a center console. The steering unit 4, the accelerator operation unit 5, the brake operation unit 6, the shift operation unit 7, and the like, are not limited to these components.

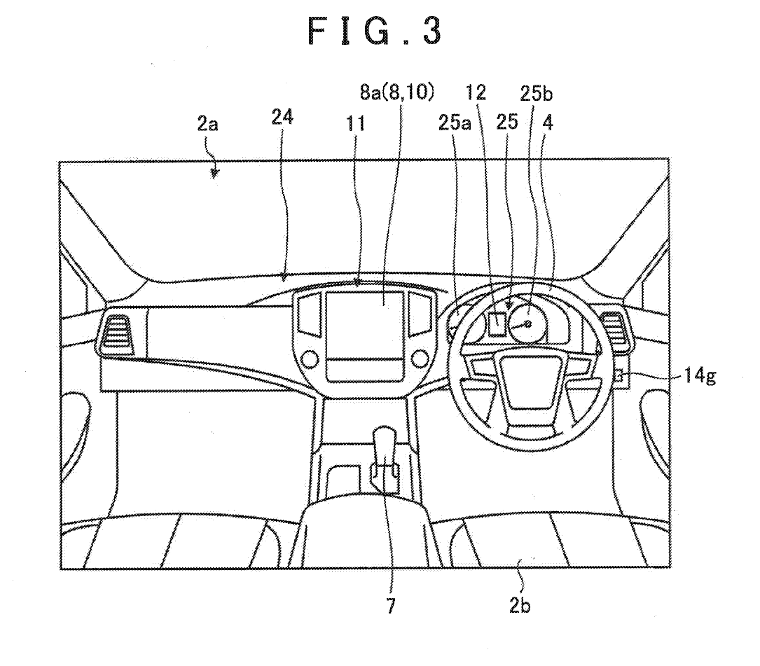

A display device 8 and an audio output device 9 are provided inside the cabin 2a. The display device 8 serves as a display output unit. The audio output device 9 serves as an audio output unit. The display device 8 is, for example, a liquid crystal display (LCD), an organic electroluminescent display (OELD), or the like. The audio output device 9 is, for example, a speaker. The display device 8 is, for example, covered with a translucent operation input unit 10, such as a touch panel. An occupant is allowed to visually recognize an image that is displayed on the display screen of the display device 8 via the operation input unit 10. An occupant is allowed to perform an input operation by operating the operation input unit 10 through touching, pressing or moving the operation input unit 10 with a finger, or the like, at a position corresponding to an image that is displayed on the display screen of the display device 8. These display device 8, audio output device 9, operation input unit 10, and the like, are, for example, provided in a monitor device 11 located at the center in the vehicle width direction, that is, transverse direction, of the dashboard 24. The monitor device 11 may have an operation input unit (not shown), such as a switch, a dial, a joystick and a push button. An audio output device (not shown) may be provided at another position inside the cabin 2a, different from the monitor device 11. Audio may be output from the audio output device 9 of the monitor device 11 and another audio output device. The monitor device 11 is, for example, shared with a navigation system or an audio system. A display device 12 (as shown in FIG. 3) different from the display device 8 is provided inside the cabin 2a.

FIG. 3 is a view of an example of a dashboard of the vehicle according to the embodiment when viewed from the rear side of the vehicle. As shown in FIG. 3, the display device 12 is, for example, provided in an instrument panel unit 25 in the dashboard 24, and is located at substantially the center of the instrument panel unit 25 between a speed indicating unit 25a and a rotation speed indicating unit 25b. The size of the screen 12a of the display device 12 is smaller than the size of the screen 8a of the display device 8 (FIG. 3). An image that shows information for assisting in parking the vehicle 1 may be mainly displayed on the display device 12. The amount of information that is displayed on the display device 12 may be smaller than the amount of information that is displayed on the display device 8. The display device 12 is, for example, an LCD, an OELD, or the like. Information that is displayed on the display device 12 may be displayed on the display device 8.

As illustrated in FIG. 1 and FIG. 2, the vehicle 1 is, for example a four-wheel vehicle, and includes two right and left front wheels 3F and two right and left rear wheels 3R. Each of these four wheels 3 may be configured to be steerable.

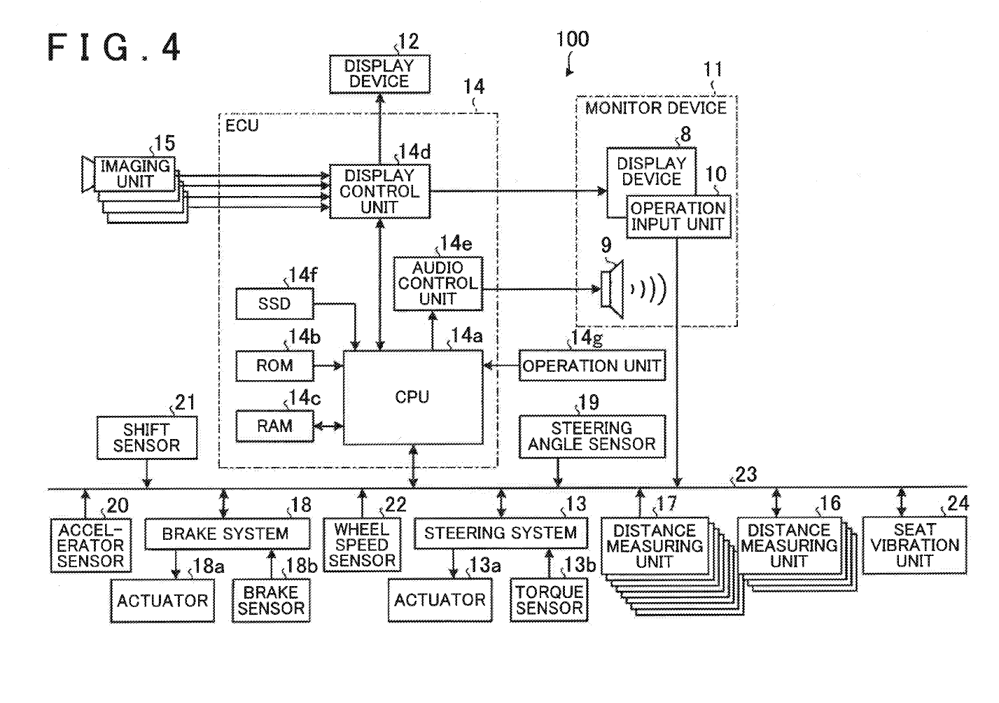

FIG. 4 is an exemplary block diagram of the configuration of a parking assist system according to the embodiment. As illustrated in FIG. 4, the vehicle 1 includes a steering system that steers at least two of the wheels 3. The steering system 13 includes an actuator 13a and a torque sensor 13b. The steering system 13 is electrically controlled by an electronic control unit (ECU) 14, or the like, to actuate the actuator 13a.

The steering system 13 is, for example, an electric power steering system, a steer-by-wire (SBW) system, or the like. The steering system 13 adds torque, that is, assist torque, to the steering unit 4 with the use of the actuator 13a to compensate for steering force or steers the wheels 3 with the use of the actuator 13a. In this case, the actuator 13a may steer one of the wheels 3 or may steer a plurality of the wheels 3. The torque sensor 13b, for example, detects a torque that is applied to the steering unit 4 by a driver.

As illustrated in FIG. 2, for example, four imaging units 15a to 15d are provided on the vehicle body 2 as a plurality of imaging units 15. Each of the imaging units 15 is, for example, a digital camera that incorporates an imaging device, such as a charge coupled device (CCD) and a CMOS image sensor (CIS). Each of the imaging units 15 is able to output moving image data at a predetermined frame rate. Each of the imaging units 15 has a wide angle lens or a fisheye lens, and is able to capture an image in, for example, the range of 140° to the range of 190° in the horizontal direction. The optical axis of each of the imaging units 15 is set so as to be oriented obliquely downward. Thus, each of the imaging units 15 sequentially captures a road surface on which the vehicle 1 is allowed to move and an outside environment around the vehicle body 2, including an area in which the vehicle 1 is allowed to be parked, and outputs the captured image as captured image data.

The imaging unit 15a is, for example, located at a rear end 2e of the vehicle body 2, and is provided at a lower wall portion of a door 2h of a rear boot. The imaging unit 15b is, for example, located at a right-side end 2f of the vehicle body 2, and is provided at a right-side door mirror 2g. The imaging unit 15c is, for example, located at the front of the vehicle body 2, that is, a front end 2c in the vehicle longitudinal direction, and is provided at a front bumper, or the like. The imaging unit 15d is, for example, located at the left side of the vehicle body 2, that is, a left-side end 2d in the vehicle width direction, and is provided at a door mirror 2g that serves as a left-side projecting portion. The ECU 14 is able to generate an image having a wider viewing angle or generate an imaginary bird's-eye image of the vehicle 1 from above by executing operation processing and image processing on the basis of the image data obtained by the imaging units 15. A bird's-eye image may be referred to as plan image.

The ECU 14 identifies partition lines, or the like, on a road surface around the vehicle 1 from the images of the imaging units 15, and detects (extracts) parking spaces indicated by the partition lines, or the like.

As illustrated in FIG. 1 and FIG. 2, for example, four distance measuring units 16a to 16d and eight distance measuring units 17a to 17h are provided on the vehicle body 2 as a plurality of distance measuring units 16, 17. Each of the distance measuring units 16, 17 is, for example, a sonar that emits ultrasonic wave and captures the reflected wave. The sonar may also be referred to as a sonar sensor or an ultrasonic detector. The ECU 14 is able to detect whether there is an object, such as an obstacle, located around the vehicle 1 or measure a distance to the object on the basis of the detected results of the distance measuring units 16, 17. That is, each of the distance measuring units 16, 17 is an example of a detection unit that detects an object. Each of the distance measuring units 17 may be, for example, used to detect an object at a relatively close distance. Each of the distance measuring units 16 may be, for example, used to detect an object at a relatively long distance, which is distant from an object that each of the distance measuring units 17 detects. The distance measuring units 17 may be, for example, used to detect an object ahead of or behind the vehicle 1. The distance measuring units 16 may be, for example, used to detect an object to the side of the vehicle 1.

As illustrated in FIG. 4, in a parking assist system 100, in addition to the ECU 14, the monitor device 11, the steering system 13, the distance measuring units 16, 17, and the like, a brake system 18, a steering angle sensor 19, an accelerator sensor 20, a shift sensor 21, a wheel speed sensor 22, and the like, are electrically connected to one another via an in-vehicle network 23 that serves as an electric communication line. The in-vehicle network 23 is, for example, provided as a controller area network (CAN). The ECU 14 is able to control the steering system 13, the brake system 18, and the like, by transmitting control signals through the in-vehicle network 23. The ECU 14 is able to receive detected results of the torque sensor 13b, a brake sensor 18b, the steering angle sensor 19, the distance measuring units 16, the distance measuring units 17, the accelerator sensor 20, the shift sensor 21, the wheel speed sensor 22, and the like, and operation signals of the operation input unit 10, and the like, via the in-vehicle network 23.

The ECU 14, for example, includes a central processing unit (CPU) 14a, a read only memory (ROM) 14b, a random access memory (RAM) 14c, a display control unit 14d, an audio control unit 14e, a solid state drive or flash memory (SSD) 14f, and the like. The CPU 14a is, for example, able to execute various operation processing and control, such as image processing related to images that are displayed on the display devices 8, 12, determination of a moving target position of the vehicle 1, computation of a moving path of the vehicle 1, determination as to whether there is an interference with an object, automatic control over the vehicle 1, and cancellation of automatic control. The CPU 14a is able to read a program installed and stored in a nonvolatile storage device, such as the ROM 14b, and execute operation processing in accordance with the program. The RAM 14c temporarily stores various pieces of data that are used for computation in the CPU 14a. The display control unit 14d mainly executes image processing by the use of image data obtained by the imaging units 15, synthesis of image data that are displayed on the display device 8, and the like, within the operation processing in the ECU 14. The audio control unit 14e mainly processes audio data that are output from the audio output device 9 within the operation processing in the ECU 14. The SSD 14f is a rewritable nonvolatile storage unit, and is able to store data even when the power of the ECU 14 is turned off. The CPU 14a, the ROM 14b, the RAM 14c, and the like, may be integrated within the same package. The ECU 14 may be formed of another logical operation processor, such as a digital signal processor (DSP), a logical circuit, or the like, instead of the CPU 14a. A hard disk drive (HDD) may be provided instead of the SSD 14f. The SSD 14f or the HDD may be provided separately from the ECU 14.

The brake system 18 is, for example, an anti-lock brake system (ABS) that prevents the brake from locking up the wheels, a side slip prevention device (electronic stability control (ESC)) that prevents a side slip of the vehicle 1 during cornering, an electric brake system that enhances brake force (performs brake assist), a brake-by-wire (BBW), or the like. The brake system 18 imparts braking force to the wheels 3 and then, the vehicle 1, via the actuator 18a. The brake system 18 is able to execute various controls by detecting locking up of the wheels by the brake, a spin of the wheels 3, a sign of a side slip, and the like, from, for example, a rotation difference between the right and left wheels 3. The brake sensor 18b is, for example, a sensor that detects the position of a movable unit of the brake operation unit 6. The brake sensor 18b is, for example, a sensor that detects the position of a brake pedal that serves as a movable unit of the brake operation unit 6. The brake sensor 18b includes a displacement sensor.

The steering angle sensor 19 is, for example, a sensor that detects a steering amount of the steering unit 4, such as the steering wheel. The steering angle sensor 19 is, for example, provided by using a Hall element, or the like. The ECU 14 acquires a driver's steering amount of the steering unit 4, a steering amount of each wheel 3 during automatic steering, or the like, from the steering angle sensor 19, and executes various controls. The steering angle sensor 19 detects a rotation angle of a rotating portion included in the steering unit 4. The steering angle sensor 19 is an example of an angle sensor.

The accelerator sensor 20 is, for example, a sensor that detects the position of a movable unit of the accelerator operation unit 5. The accelerator sensor 20 is able to detect the position of the accelerator pedal that serves as the movable unit of the accelerator operation unit 5. The accelerator sensor 20 includes a displacement sensor.

The shift sensor 21 is, for example, a sensor that detects the position of a movable unit of the shift operation unit 7. The shift sensor 21 is able to detect the position of a lever, an arm, a button, or the like, that serves as the movable unit of the shift operation unit 7. The shift sensor 21 may include a displacement sensor or may be provided as a switch.

The wheel speed sensor 22 is a sensor that detects a rotation amount or rotation speed of each wheel 3 per unit time. The wheel speed sensor 22 outputs a wheel speed pulse number, indicating the detected rotation speed, as a sensor value. The wheel speed sensor 22 may be, for example, provided by using a Hall element, or the like. The ECU 14 computes a moving amount, and the like, of the vehicle 1 on the basis of the sensor value acquired from the wheel speed sensor 22, and executes various controls. There is a case where the wheel speed sensor 22 is provided in the brake system 18. In this case, the ECU 14 acquires the detected result of the wheel speed sensor 22 via the brake system 18.

The configurations, arrangement, electrical connection modes, and the like, of the above-described various sensors and actuators are illustrative, and may be variously set (changed).

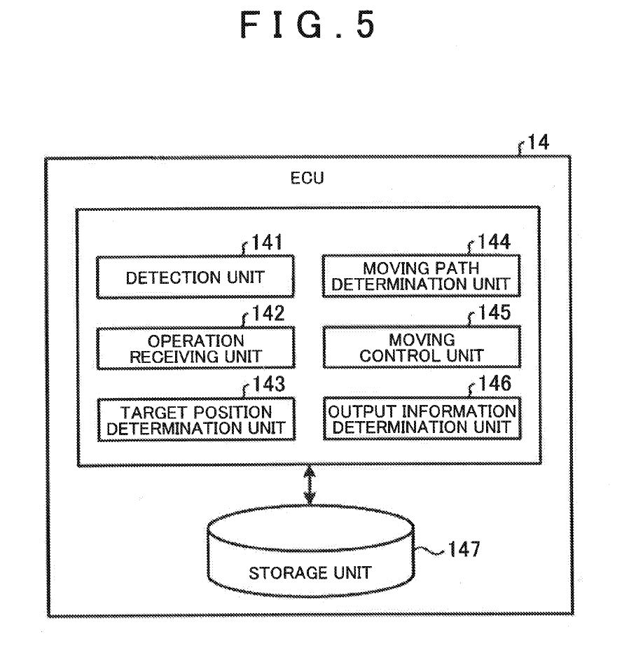

In the present embodiment, the ECU 14 implements at least part of the function of a parking assist system by cooperation between hardware and software (control program). FIG. 5 is a functional configuration block diagram of the ECU. As shown in FIG. 5, the ECU 14 functions as a detection unit 141, an operation receiving unit 142, a target position determination unit 143, a moving path determination unit 144, a moving control unit 145, an output information determination unit 146 and a storage unit 147.

In the above configuration, the detection unit 141 detects an obstacle, such as another vehicle and a pole, a frame line, such as a parking space line, and the like. The operation receiving unit 142 acquires an operation signal that is input through operation of an operation unit 14g. The operation unit 14g is, for example, formed of a push button, a switch, or the like, and outputs an operation signal. The target position determination unit 143 determines a moving target position (parking target position) of the vehicle 1. The moving path determination unit 144 determines a moving path of the vehicle 1 to the moving target position. The moving control unit 145 controls the portions of the vehicle 1 such that the vehicle 1 moves to the moving target position (parking target position) along the moving path. The output information determination unit 146 determines information that is output through the display device 12, the display device 8, the audio output device 9, or the like, and determines an output mode of the information, and the like. The storage unit 147 stores data that are used in computation in the ECU 14 or data calculated in computation in the ECU 14.

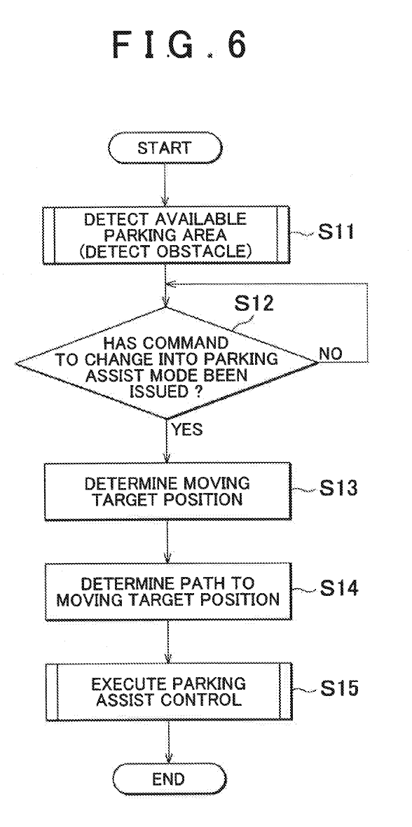

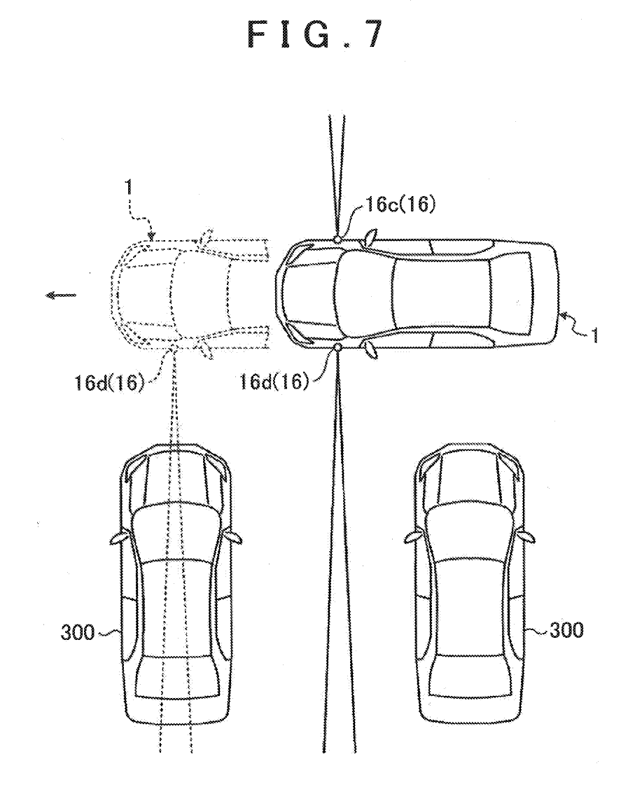

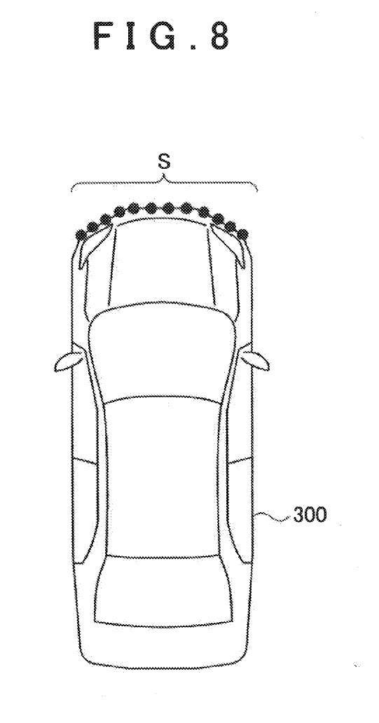

Next, the operation of the embodiment will be described. FIG. 6 is a flowchart of a schematic process according to the embodiment. Initially, the ECU 14 detects an available parking area (detects an obstacle) (step S11). FIG. 7 is a view that illustrates detection of an available parking area. FIG. 8 is a view that illustrates a reflected portion of an obstacle.

Specifically, the distance measuring units 16c, 16d calculate a distance to an obstacle, such as another vehicle 300, at intervals of predetermined sampling timing, and outputs the distance as data corresponding to a reflected portion S (a set of reflected points of a sonic wave, or the like) of the obstacle. The output data are, for example, stored in the RAM 14c at output intervals.

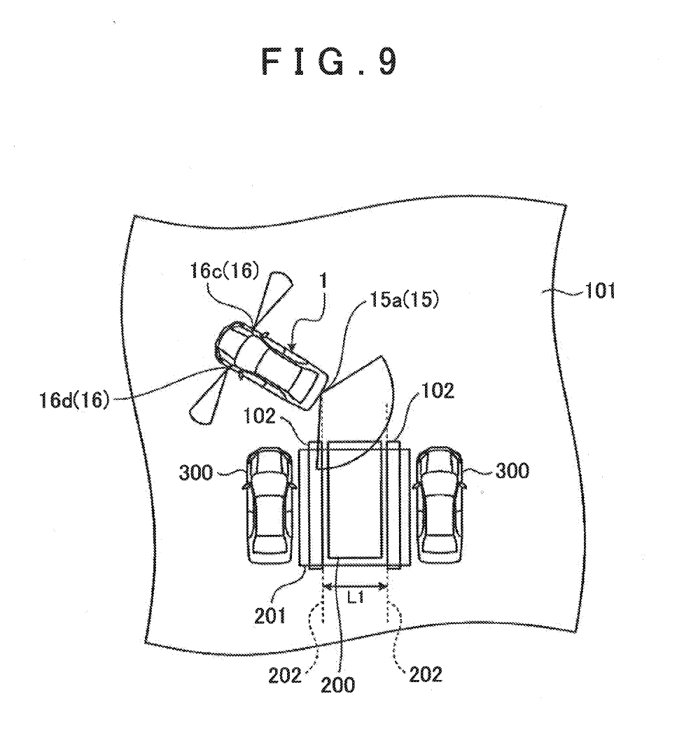

The ECU 14 functions as the detection unit 141, and detects available parking areas 201 (as shown in FIG. 9) located on both right and left sides of the vehicle 1 independently of each other on the basis of the output data of the distance measuring units 16c, 16d. For the sake of easy understanding, a method of detecting the available parking area 201 on the left side of the vehicle 1 will be described.

FIG. 9 is a view that illustrates an available parking area. The detection unit 141 determines that there is the available parking area 201 when output data corresponding to an obstacle are output for a period longer than or equal to a period corresponding to a first predetermined duration and, after that, when output data corresponding to the case where there is no obstacle (including the case where a distance to an obstacle is longer than or equal to the vehicle longitudinal length required for the vehicle to park) are output for a period longer than or equal to a second predetermined duration corresponding to a minimum width required as an area in which the vehicle 1 is allowed to be parked.

The detection unit 141 detects a parking space line 102, such as a white line, provided on a traveling surface, such as a ground surface and a road surface, on the basis of captured data output from the imaging unit 15a that captures the rear side of the vehicle 1. More specifically, the detection unit 141 detects a parking space line 102 by applying edge extraction to captured data output from the imaging units 15a to 15d in process in which the vehicle 1 moves backward, in process in which the vehicle 1 moves forward, or during a stop of the vehicle 1.

Subsequently, the ECU 14 functions as the operation receiving unit 142, and determines whether a command to change into the parking assist mode has been issued via the operation unit 14g (step S 12). When it is determined in step S12 that a command to change into the parking assist mode has not been issued via the operation unit 14g yet (No in step S 12), the process enters a standby state. When it is determined in step S12 that a command to change into the parking assist mode has been issued via the operation unit 14g (Yes in step S12), the ECU 14 functions as the target position determination unit 143, and determines a moving target position (parking target position) 200 of the vehicle 1 (step S13). Subsequently, the ECU 14 functions as the moving path determination unit 144, and determines a moving path to the moving target position 200 of the vehicle 1 (step S14).

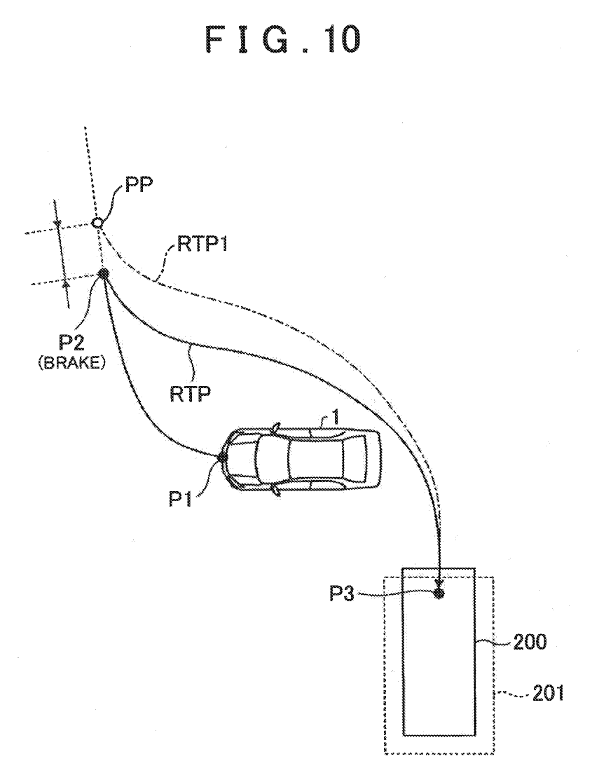

FIG. 10 is a view that illustrates an example of a set moving path. For the sake of simplification of description, the case of the moving path in which the switching position at which the steering wheel that serves as the steering unit 4 is required to turn is one will be described with reference to FIG. 10. The switching position may be regarded as a position at which the steering wheel is required to turn and at which a moving direction of the vehicle is changed between a forward direction and a reverse direction.

In the moving path RTP shown in FIG. 10, the vehicle 1 is moved forward from an initial position P1 at the start of a parking assist control process toward the switching position P2 of the steering wheel that serves as the steering unit 4 by turning the steering wheel rightward by a predetermined amount, the vehicle 1 is stopped at the switching position P2 by depressing the brake that serves as the brake operation unit 6, the gear is changed into reverse, and the vehicle 1 is moved toward the parking target position P3 while turning the steering wheel that serves as the steering unit 4 leftward.

When the moving path RTP is determined, the ECU 14 changes into parking assist control (step S15).

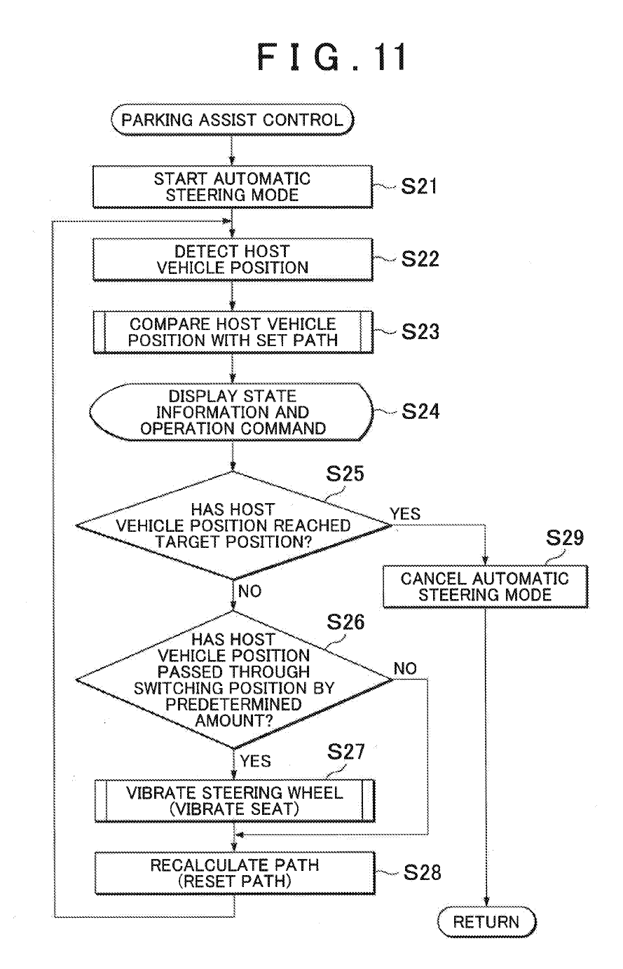

FIG. 11 is a process flowchart of a parking assist control process. Initially, the ECU 14 functions as the moving control unit 145, starts the automatic steering mode for automatic steering in order to control the portions of the vehicle 1 such that the vehicle 1 moves to the parking target position that is the moving target position along the moving path (step S21).

In this automatic steering mode, the driver does not need to operate the steering unit 4, specifically, the steering wheel. Creeping in which the driving force of the engine is transmitted without depressing operation of the accelerator pedal, which is an operation of the accelerator operation unit 5, is utilized for the forward driving force and reverse driving force of the vehicle 1 during the parking assist control process.

Therefore, the driver just operates the brake pedal that serves as the brake operation unit 6 and the shift lever that serves as the shift operation unit 7 in accordance with display on the display device 12. Subsequently, the moving control unit 145 detects a host vehicle position (step S22). Specifically, the ECU 14 detects the host vehicle position by calculating a distance and a direction that are a moving amount from the initial position P1 on the basis of the steering amount of the steering unit 4, detected by the steering angle sensor 19, and the vehicle speed detected by the wheel speed sensor 22.

Thus, the ECU 14 compares the set path with the host vehicle position (step S23), functions as the output information determination unit 146 to determine information about the state of the vehicle and an operation command to the driver and display the information about the state of the vehicle and the operation command on the display device 12 (step S24).

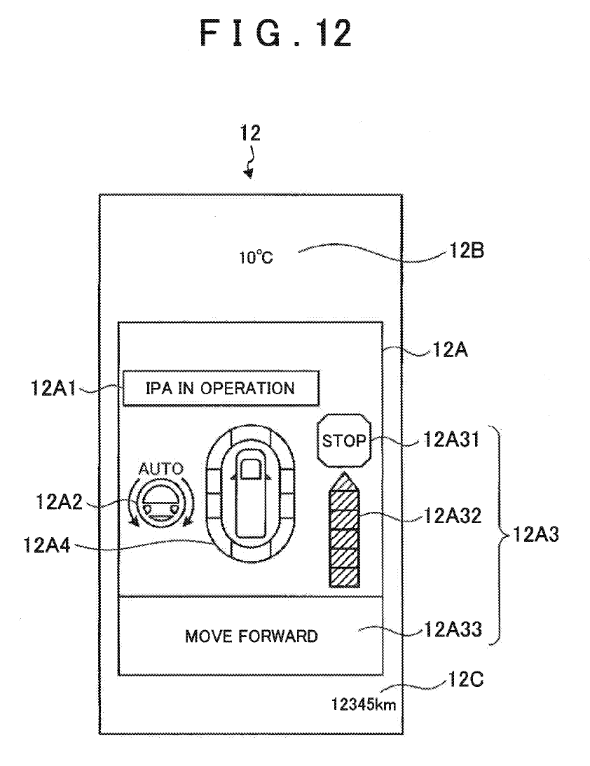

FIG. 12 is a view that illustrates an example of display at the start of the parking assist control process. The display screen of the display device 12 roughly includes a parking assist information display region 12A, a selected information display region 12B and a travel distance information display region 12C. The parking assist information display region 12A displays various pieces of information about parking assist. The selected information display region 12B displays various pieces of information selected in advance. The travel distance information display region 12C is able to display information about an odometer or a trip meter.

The parking assist information display region 12A includes a parking assist display region 12A1, an automatic steering symbol display region 12A2, an operation command display region 12A3 and an obstacle display region 12A4. The parking assist display region 12A1 displays that parking assist (intelligent parking assist (IPA)) is in operation when it is actually in operation. The automatic steering symbol display region 12A2 displays a symbol that indicates that it is in the automatic steering mode during the automatic steering mode. The operation command display region 12A3 displays an operation command to the driver. The obstacle display region 12A4 displays a direction in which an obstacle is located when it is detected by the distance measuring units 16, 17 that the obstacle is located within a predetermined distance range around the vehicle 1.

In the above configuration, as shown in FIG. 12, a braking operation symbol 12A31, a distance indication symbol 12A32 and a command display region 12A33 are displayed in the operation command display region 12A3. The braking operation symbol 12A31 is set in a lit state at the time when a command to operate the brake that serves as the brake operation unit 6 is issued. The distance indication symbol 12A32 indicates a measure of a distance to the switching position of the steering wheel that serves as the steering unit 4 or a measure of a distance to the moving target position by stepwisely changing from a fully lit state to an unlit state. The command display region 12A33 displays details of a command to the driver.

That is, in the case of FIG. 12, the display device 12 displays that parking assist is in operation, it is in the automatic steering mode, a distance to the switching position P2 of the steering wheel that serves as the steering unit 4 or the parking target position P3 that serves as the moving target position is still left near 100%, and the details of a command instructs the driver to stop depressing the brake pedal that serves as the brake operation unit 6 and allows the vehicle 1 to move forward by creeping.

Subsequently, the ECU 14 functions as the moving control unit 145, and determines whether the host vehicle position has reached the parking target position P3 that serves as the target position (step S25).

In this case, because it is determined in step S25 that the host vehicle position has not reached the parking target position P3 that serves as the target position yet (No in step S25), it is determined whether the host vehicle position has passed the switching position P2 by a predetermined amount (step S26).

The predetermined amount is represented by a distance from the switching position P2 or an elapsed time from time at which the host vehicle position has passed through the switching position P2. That is, the predetermined amount corresponds to the timing at which the ECU 14 is allowed to reliably determine that the driver has not visually recognized parking assist information about the switching position P2.

In this case, because it is determined in step S26 that the host vehicle position has not passed through the switching position P2 by the predetermined amount yet (No in step S26), the ECU 14 functions as the moving path determination unit 144 again, recalculates a moving path, and resets a moving path (step S28). This is because the vehicle 1 does not always travel along a set moving path depending on a road surface condition, or the like, and, therefore, an optimal moving path is kept commensurately with an actual condition. The ECU 14 proceeds to step S22 again, and repeats a similar process thereafter.

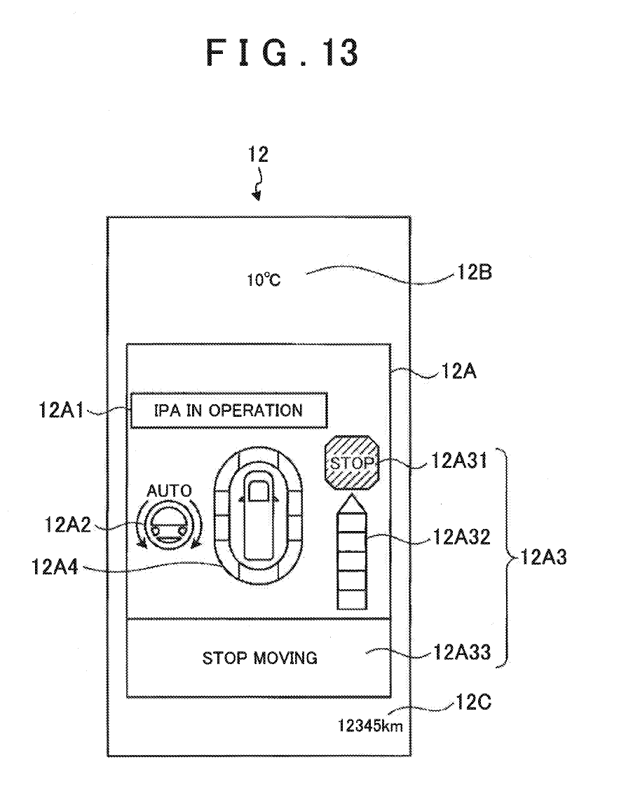

FIG. 13 is a view that illustrates an example of display in the case where the host vehicle position has reached the switching position. The ECU 14 detects the host vehicle position (step S22), and compares the host vehicle position with the set path (step S23). As a result, when the host vehicle position has reached the switching position P2 of the steering wheel that serves as the steering unit 4, the ECU 14 sets the braking operation symbol 12A31 in a lit state, displays, for example, “STOP MOVING” in the command display region 12A33, and issues a command to operate the brake that serves as the brake operation unit 6 to the driver (step S24).

In the above description, when the host vehicle position has reached the switching position P2 of the steering wheel that serves as the steering unit 4, the braking operation symbol 12A31 is set to a lit state, and a command to operate the brake that serves as the brake operation unit 6 is issued to the driver by displaying the operation command in the command display region 12A33. However, for example, when the path is a downhill, or the like, even when the vehicle is driven by the use of creeping or when the driver is caused to depress the accelerator that serves as the accelerator operation unit 5, the speed of the vehicle 1 resulting from creeping or depression of the accelerator becomes higher than a predetermined reference speed. Therefore, a similar operation command may be configured to be issued before the host vehicle position reaches the switching position P2 of the steering wheel that serves as the steering unit 4. The ECU 14 determines whether the host vehicle position has reached the target position (step S25).

When it is determined in step S25 that the host vehicle position has not reached the target position (No in step S25), and when it is determined in step S26 that the host vehicle position has passed through the switching position P2 by the predetermined amount (Yes in step S26), the ECU 14 functions as a notification control unit, and drives the actuator 13a that serves as the driving unit to vibrate the steering wheel that serves as the steering unit 4 in order to provide a notice that the host vehicle position has passed through the switching position P2 and continues moving on the assumption that the driver has not recognized yet that the host vehicle position has passed through the switching position P2 (step S27). In this case, the ECU 14 may be configured to issue the operation command as issued in step S24 as the notification control unit through the display device 12 again.

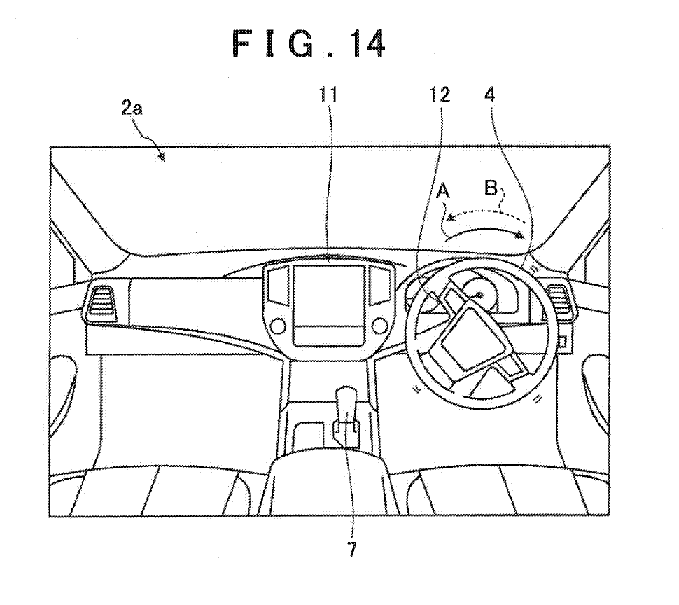

FIG. 14 is a view that shows a vibrating state of the steering unit. Specifically, the steering wheel that serves as the steering unit 4 is vibrated by alternately switching between rotation in the arrow A direction (first direction, clockwise direction) and rotation in the arrow B direction (second direction, counter-clockwise direction) opposite to the arrow A direction. In this case, vibrations that are generated by the actuator 13a desirably have a vibration pattern that is not generated in ordinary driving.

That is, the vibration pattern may be arbitrarily set by keeping the rotation angle constant and changing the frequency of switching the rotation direction (variable frequency at a constant amplitude of vibrations), changing the rotation angle (variable amplitude of vibrations) and keeping the frequency of switching the rotation direction constant, changing the rotation angle and the frequency of switching the rotation direction (variable amplitude of vibrations and variable frequency of vibrations) or combining any of these patterns.

In the above description, the steering wheel that serves as the steering unit 4 is alternately switched between rotation in the arrow A direction (first direction, clockwise direction) and rotation in the arrow B direction (second direction, counter-clockwise direction) opposite to the arrow A direction. However, the steering wheel does not always need to be alternately switched. The steering wheel may be rotated in the arrow A direction and stopped, rotated in the arrow A direction again and stopped, then rotated in the arrow B direction and stopped, and rotated in the arrow B direction again and stopped.

Furthermore, the steering wheel may be configured to change the number of rotations such that the steering wheel is rotated in the arrow A direction and stopped successively twice, rotated in the arrow B direction and stopped, rotated in the arrow A direction and stopped and then rotated in the arrow B direction and stopped successively twice.

A seat vibration control device and a seat vibration unit 24 installed in a driver's seat are further provided, and the seat vibration control device, in synchronization with vibrations of the steering wheel, executes control for generating vibrations in the seat (driver's seat) on which the driver is seated to vibrate the driver's seat by driving an actuator that constitutes the seat vibration unit. Thus, the driver may be further reliably provided with a notice that the host vehicle position has passed through the switching position P2 and continues moving.

Therefore, the driver is allowed to reliably acquire the fact that the vehicle 1 is caused to continue moving after passing through the switching position P2, is allowed to reliably perform operation of the vehicle 1, required during parking assist, and is allowed to reliably perform parking. More specifically, in the case of the example shown in FIG. 10, the driver does not significantly deviate from the switching position P2, and is allowed to stop the vehicle 1 at the position PP by reliably depressing the brake pedal that serves as the movable unit of the brake operation unit 6.

The ECU 14 functions as the moving path determination unit 144 again, recalculates a moving path, and resets a moving path (step S28). Thus, even when the vehicle has reached the position PP through the switching position P2 because of the fact that the driver does not recognize the parking assist information displayed on the display device 12, it is possible to set a new moving path RTP1 indicated by the alternate long and short dash line in FIG. 10.

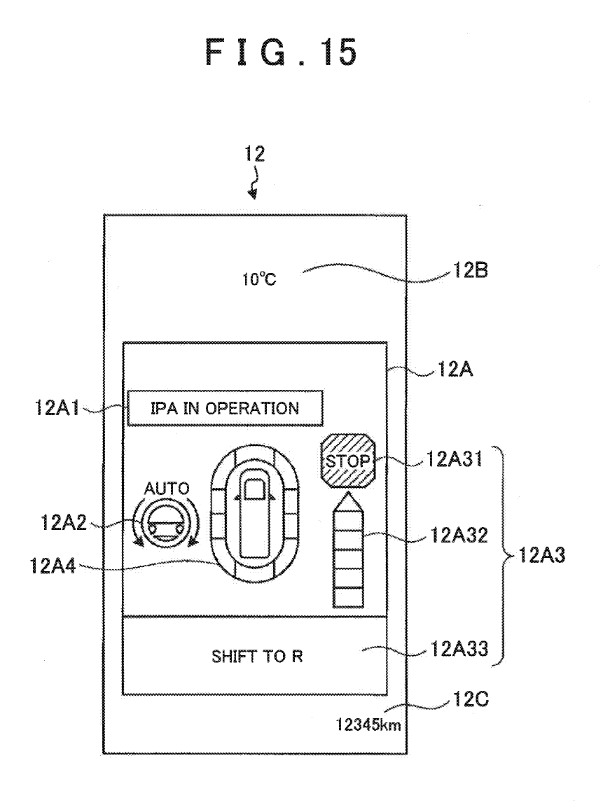

FIG. 15 is a view that illustrates an example of information display at a new switching position. When the ECU 14 proceeds to step S22 again and detects that the host vehicle position has reached the position PP and the vehicle 1 is stopped (step S22), the ECU 14 sets the position PP for a new switching position instead of the switching position P2, sets the braking operation symbol 12A31 in a lit state, displays, for example, “SHIFT TO R” in the command display region 12A33, and issues an operation command to the driver to change the shift lever that serves as the shift operation unit 7 to reverse (R) (step S24).

Thus, when it is determined in step S25 that the host vehicle position has not reached the target position yet (No in step S25), and when it is determined in step S26 that the host vehicle position does not pass through a switching position by the predetermined amount because there is no next switching position (No in step S26), the ECU 14 functions as the moving path determination unit 144 again, recalculates a moving path, and resets a moving path (step S28).

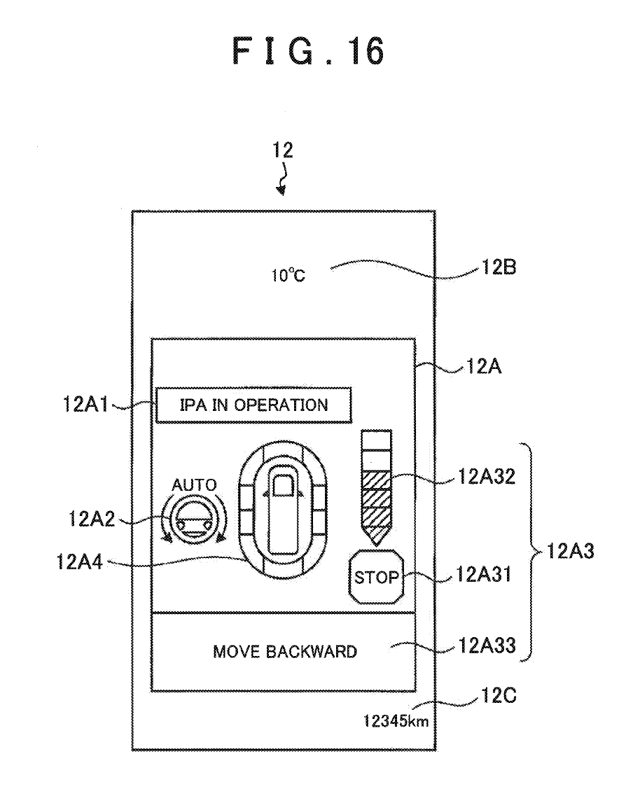

FIG. 16 is a view that illustrates an example of information display while the vehicle is moving backward. When the ECU 14 proceeds to step S22 again and detects that the host vehicle position has reached the position PP to stop the vehicle 1 and a change of the shift lever that serves as the shift operation unit 7 to reverse (R), the ECU 14 compares the host vehicle position with the set path (step S23), and issues an operation command to move the vehicle 1 backward (step S24).

Thus, when it is determined in step S25 that the host vehicle position has not reached the target position yet (No in step S25), and when it is determined in step S26 that the host vehicle position does not pass through the switching position by the predetermined amount because there is no next switching position (No in step S26), the ECU 14 functions as the moving path determination unit 144 again, recalculates a moving path, and resets a moving path (step S28). The ECU 14 proceeds to step S22 again, detects the host vehicle position (step S22), compares the host vehicle position with the set path (step S23), and displays a measure of a distance to the moving target position (in this case, the parking position P3) while updating a lit state of the distance indication symbol 12A32 (step S24).

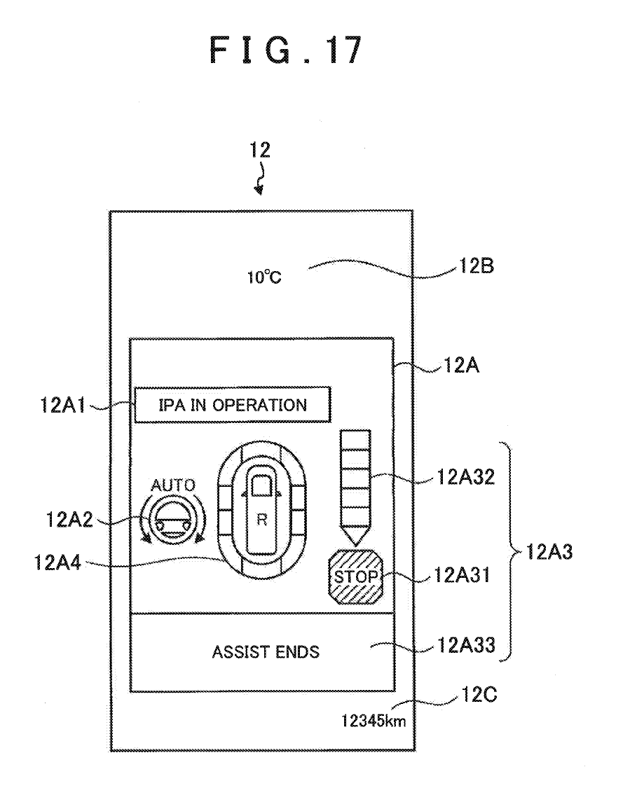

FIG. 17 is a view that illustrates an example of display at the end of parking assist. In addition, the ECU 14 proceeds to step S22 again through the processes of step S25, step S26 and step S28, detects the host vehicle position (step S22), compares the host vehicle position with the set path (step S23), displays state information and operation command information on the display screen of the display device 12 (step S24), cancels the automatic steering mode (step S29) when it is determined in step S25 that the host vehicle position has reached the parking position P3 that is the target position (Yes in step S25), and displays the end of the parking assist process in the command display region 12A33 and ends the parking assist process.

As described above, according to the embodiment, when parking assist is performed, it is possible to reliably provide the driver with a notice that the host vehicle position has reached and passed through the switching position. Therefore, a delay of operation of the vehicle 1 required during parking assist is reduced, and parking is quickly performed. A notice that the host vehicle position has reached and passed through the switching position is provided by vibrations of the steering wheel, so it is possible to reliably transmit information to a hearing-impaired driver.

The embodiment of the invention is described above; however, the embodiment is only illustrative and not intended to limit the scope of the invention. This novel embodiment may be implemented in other various forms, and may be variously omitted, replaced or changed without departing from the spirit of the invention. The scope and spirit of the invention encompass the embodiment and its modifications, and the invention described in the appended claims and equivalents thereof encompass these embodiments and their modifications.

For example, in the above description, even when the host vehicle position has passed through the switching position P2, the speed of the vehicle 1 is not subjected to any control. Instead, in the automatic steering mode, a moving distance after passage may be reduced by decreasing the speed during creeping through a decrease in engine rotation speed or the vehicle may be stopped.

With such a configuration, it is possible to omit the process of recalculating the set path or reducing a load on the recalculation process. In addition, a delay of operation of the vehicle 1 required during parking assist is reduced, and parking is quickly performed.

In the above description, the steering wheel is vibrated by the actuator 13a. Instead, a vibration device, such as another vibrator, may be provided.

A first aspect of the invention provides a parking assist system. The parking assist system includes an electronic control unit 14. The electronic control unit 14 is configured to detect that a vehicle has moved through a switching position P2 at which the steering wheel is required to turn and reached a predetermined state PP during parking assist for the vehicle, and, when it is detected that the vehicle has reached the predetermined state, provide a notice that the vehicle has reached the predetermined state by imparting a predetermined vibration to a steering wheel of the vehicle. According to the above first aspect, when parking assist is performed, it is possible to reliably provide a driver with a notice that the vehicle has reached and passed through the switching position.

In the parking assist system according to the first aspect, the vehicle may include a driving unit 13a configured to rotationally drive the steering wheel, and the electronic control unit may be configured to control the driving unit to impart the vibration by switching between rotation of the steering wheel in a first direction and rotation of the steering wheel in a second direction opposite to the first direction.

With the above configuration, the vibration is imparted by the driving unit 13a that rotationally drives the steering wheel, so, without an increase in device cost or ensuring an installation space, it is possible to reliably provide the driver with a notice that the vehicle has reached and passed through the switching position when parking assist is performed.

In the parking assist system according to the first aspect, the predetermined state may be a state where the vehicle has continued moving a predetermined distance or longer or for a predetermined time or longer after reaching the switching position. With the above configuration, it is possible to reliably transmit information at the switching position to the driver who is estimated not to visually recognize the information.

In the parking assist system according to the first aspect, the vehicle may include a display device 12 configured to display parking assist information, and the electronic control unit may be configured to, after it is detected that the vehicle has reached the predetermined state, cause the display device to display the parking assist information at a newly set switching position at which the steering wheel is required to turn. With the above configuration, it is possible to constantly quickly provide latest parking assist information to the driver.

In the parking assist system according to the first aspect, the electronic control unit may be configured to, when a speed at which the vehicle travels toward a next switching position is higher than a predetermined reference speed, advance timing of displaying the parking assist information at the next switching position on the display device as compared to when the speed is lower than or equal to the predetermined reference speed. With the above configuration, parking assist is performed in consideration of a time lag between providing parking assist information to the driver and an actual driver's operation based on the provided parking assist information.

In the parking assist system according to the first aspect, the electronic control unit may be configured to detect that the vehicle has reached the switching position, and decrease a speed of the vehicle at time at which the vehicle has reached the switching position. With the above configuration, it is possible to suppress a moving distance after passing through the switching position, so parking assist is further efficiently performed.

A second aspect of the invention provides a parking assist method that is executed in a parking assist system mounted on a vehicle including a driving unit 13a that rotationally drives a steering wheel. The parking assist method includes: detecting that the vehicle has moved through a switching position P2 at which the steering wheel is required to turn and reached a predetermined state PP during parking assist for the vehicle; and, when it is detected that the vehicle has reached the predetermined state, providing a notice that the vehicle has reached the predetermined state by imparting a vibration by switching between rotation of the steering wheel in a first direction and rotation of the steering wheel in a second direction opposite to the first direction. According to the above second aspect, when parking assist is performed, it is possible to reliably provide a driver with a notice that the vehicle has reached and passed through the switching position.

A third aspect of the invention provides a control program for controlling, by a computer, a parking assist system mounted on a vehicle including a driving unit 13a that rotationally drives a steering wheel. The control program causes the computer to function as: means for detecting that the vehicle has moved through a switching position P2 at which the steering wheel is required to turn and reached a predetermined state PP during parking assist for the vehicle; and means for, when it is detected that the vehicle has reached the predetermined state, providing a notice that the vehicle has reached the predetermined state by controlling the driving unit 13a to impart a vibration by switching between rotation of the steering wheel in a first direction and rotation of the steering wheel in a second direction opposite to the first direction. According to the above third aspect, when parking assist is performed, it is possible to reliably provide a driver with a notice that the vehicle has reached and passed through the switching position.

What is claimed is:

1. A parking assist system for a vehicle, comprising:
an electronic control unit configured to
detect that the vehicle has moved through a switching position at which a steering wheel of the vehicle is required to turn and reached a predetermined state during parking assist for the vehicle, and
when it is detected that the vehicle has reached the predetermined state, provide a notice that the vehicle has reached the predetermined state by imparting a predetermined vibration to a steering wheel of the vehicle.

2. The parking assist system according to claim 1, wherein
the vehicle includes a driving unit configured to rotationally drive the steering wheel, and
the electronic control unit is configured to control the driving unit to impart the vibration by switching between rotation of the steering wheel in a first direction and rotation of the steering wheel in a second direction opposite to the first direction.

3. The parking assist system according to claim 1, wherein
the electronic control unit is configured to, when the predetermined vibration is imparted to the steering wheel, perform at least one of (i) changing a frequency of switching a rotation direction of the steering wheel or (ii) changing a rotation angle of the steering wheel in the first direction and a rotation angle of the steering wheel in the second direction.

4. The parking assist system according to claim 1, further comprising:
a seat vibration unit configured to vibrate a driver seat, wherein
the electronic control unit is configured to, when it is detected that the vehicle has reached the predetermined state, provide a notice that the vehicle has reached the predetermined state by vibrating the driver seat with the use of the seat vibration unit.

5. The parking assist system according to claim 1, wherein
the predetermined state is a state where the vehicle has continued moving a predetermined distance or longer or for a predetermined time or longer after reaching the switching position.

6. The parking assist system according to claim 1, wherein
the vehicle includes a display device configured to display parking assist information, and
the electronic control unit is configured to, after it is detected that the vehicle has reached the predetermined state, cause the display device to display the parking assist information at a newly set switching position.

7. The parking assist system according to claim 6, wherein
the electronic control unit is configured to, when a speed at which the vehicle travels toward a next switching position is higher than a predetermined reference speed, advance timing of displaying the parking assist information at the next switching position on the display device as compared to when the speed is lower than or equal to the predetermined reference speed.

8. The parking assist system according to claim 1, wherein
the electronic control unit is configured to detect that the vehicle has reached the switching position, and decrease a speed of the vehicle at time at which the vehicle has reached the switching position.

9. The parking assist system according to claim 1, wherein
the switching position is a position at which the steering wheel is required to turn and at which a moving direction of the vehicle is changed between a forward direction and a reverse direction.

10. A parking assist method that is executed in a parking assist system mounted on a vehicle including a driving unit that rotationally drives a steering wheel, the parking assist method comprising:
detecting that the vehicle has moved through a switching position at which a steering wheel of the vehicle is required to turn and reached a predetermined state during parking assist for the vehicle; and
when it is detected that the vehicle has reached the predetermined state, providing a notice that the vehicle has reached the predetermined state by imparting a vibration by switching between rotation of the steering wheel in a first direction and rotation of the steering wheel in a second direction opposite to the first direction.

11. The parking assist method according to claim 10, wherein
the predetermined state is a state where the vehicle has continued moving a predetermined distance or longer or for a predetermined time or longer after reaching the switching position.

12. The parking assist method according to claim 10, wherein
the vehicle includes a display device configured to display parking assist information, and
after it is detected that the vehicle has reached the predetermined state, the notice that the vehicle has reached the predetermined state is provided by causing the display device to display the parking assist information at a newly set switching position.

13. The parking assist method according to claim 10, wherein
the notice that the vehicle has reached the predetermined state is provided such that, when a speed at which the vehicle travels toward a next switching position is higher than a predetermined reference speed, timing of displaying the parking assist information at the next switching position on the display device is advanced as compared to when the speed is lower than or equal to the predetermined reference speed.

14. The parking assist method according to claim 10, further comprising:
detecting that the vehicle has reached the switching position; and
decreasing a speed of the vehicle at time at which the vehicle has reached the switching position.

15. A control program for controlling, by a computer, a parking assist system mounted on a vehicle including a driving unit that rotationally drives a steering wheel, the control program causing the computer to function as:
means for detecting that the vehicle has moved through a switching position at which a steering wheel of the vehicle is required to turn and reached a predetermined state during parking assist for the vehicle, and
means for, when it is detected that the vehicle has reached the predetermined state, providing a notice that the vehicle has reached the predetermined state by controlling the driving unit to impart a vibration by switching between rotation of the steering wheel in a first direction and rotation of the steering wheel in a second direction opposite to the first direction.

16. The control program according to claim 15, wherein
the predetermined state is a state where the vehicle has continued moving a predetermined distance or longer or for a predetermined time or longer after reaching the switching position.

17. The control program according to claim 15, wherein
the vehicle includes a display device configured to display parking assist information, and
after it is detected that the vehicle has reached the predetermined state, the means for providing the notice that the vehicle has reached the predetermined state causes the display device to display the parking assist information at a newly set switching position.

18. The control program according to claim 15, wherein
when a speed at which the vehicle travels toward a next switching position is higher than a predetermined reference speed, the means for providing the notice that the vehicle has reached the predetermined state advances timing of displaying the parking assist information at the next switching position on the display device as compared to when the speed is lower than or equal to the predetermined reference speed.

19. The control program according to claim 15, wherein
the control program further causes the computer to function as:
means for detecting that the vehicle has reached the switching position; and
means for decreasing a speed of the vehicle at time at which the vehicle has reached the switching position.
